(19) United States
(12) Patent Application Publication
(10) Pub. No.: US 2011/0057949 A1
(43) Pub. Date: Mar. 10, 2011

(54) SEMICONDUCTOR INTEGRATED CIRCUIT, DISPLAY DEVICE, AND DISPLAY CONTROL METHOD

(75) Inventor: Tsukasa SAITOU, Kanagawa (JP)

(73) Assignee: RENESAS ELECTRONICS CORPORATION, Kanagawa (JP)

(21) Appl. No.: 12/874,915

(22) Filed: Sep. 2, 2010

(30) Foreign Application Priority Data
Sep. 8, 2009 (JP) 2009-206656

(51) Int. Cl. G09G 5/02

(52) U.S. Cl. 345/596; 345/698

(57) ABSTRACT

A semiconductor integrated circuit includes a plurality of data hold circuits that are associated with a plurality of pixel columns arranged in a pixel arranged area where a plurality of pixels are arranged in matrix, each of the plurality of data hold circuits being configured to hold data which is to be supplied to the pixel column; and a plurality of selectors, each selector being configured to selectively supply, based on whether a shift process for dithering is to be performed or not, one of outputs of a pair of data hold circuits coupled to said selector to the pixel column included in a pair of pixel columns that is associated with said pair of data hold circuits, said pair of pixel columns comprising pixel columns positioned side by side in the pixel arranged area.

### INCORPORATION BY REFERENCE

This application is based upon and claims the benefit of priority from Japanese patent application No. 2009-206656, filed on Sep. 8, 2009, the disclosure of which is incorporated herein in its entirety by reference.

### BACKGROUND

1. Field of the Invention

The present invention relates to a semiconductor integrated circuit, display device, and display control method.

2. Description of Related Art

Demands for display devices have been increasing in accordance with the recent widespread use of mobile devices such as cellular phones. It has been desired to reduce the power consumption of the semiconductor integrated circuits used in such display device in order to increase the operation time of the mobile devices. Also, recently, in order to reduce the communication fee charged when transmitting or receiving image data via communication lines, it has become more common to lower the resolution of images thereby lowering the amount of the image data. Along with this trend, it has become more common to expand images of lower resolution and then display the expanded images on high-resolution display devices such as high-resolution liquid crystal display (LCD) panels. Accordingly, in the display devices used in the mobile devices, it has been desired to develop a technology for reducing the number of processes to display the expanded images and for reducing the consumption of current.

For example, Yoshiyuki Miyayama, “Operation and Function of LCD Driver IC for Driving Liquid Crystal Matrix to Display Characters and Images,” Transistor Technology, Japan, CQ Publishing Co., Ltd., February 2004 edition, pp. 136 to 137 describes an LCD module for cellular phones in which only necessary components operates, when the displayed image makes no changes, in order to reduce current consumption.

Japanese Unexamined Patent Application Publication No. 2003-008887 describes an image expansion control device that interpolates and expands the original image data using complicated formulas to display the expanded images.

The technology described in the Miyayama's document, however, cannot reduce current consumption if the displayed moving image constantly changes. Further, the technology cannot reduce current consumption that occurs when displaying expanded images.

On the other hand, the technology described in Japanese Unexamined Patent Application Publication No. 2003-008887 requires operations using complicated formulas. To perform such operations, an image operation circuit and a buffer for storing operation results are required separately. This disadvantageously increases current consumption.

### SUMMARY

The present inventors have found a problem that, when displaying expanded images, considerable current was consumed.

A first exemplary aspect of the present invention is a semiconductor integrated circuit including: a plurality of data hold circuits that are associated with a plurality of pixel columns arranged in a pixel arranged area where a plurality of pixels are arranged in matrix, each of the plurality of data hold circuits being configured to hold data which is to be supplied to the pixel column; and a plurality of selectors, each selector being configured to selectively supply, based on whether a shift process for dithering is to be performed or not, one of outputs of a pair of data hold circuits coupled to said selector to the pixel column included in a pair of pixel columns that is associated with said pair of data hold circuits, said pair of pixel columns comprising pixel columns positioned side by side in the pixel arranged area.

A second exemplary aspect of the present invention is a display control method including: holding data by a plurality of data hold circuits that are associated with a plurality of pixel columns included in a pixel arranged area where a plurality of pixels are arranged in matrix; and selectively supplying one of outputs of a pair of data hold circuits to the pixel column included in a pair of pixel columns, which is associated with said pair of data hold circuits and comprises pixel columns positioned side by side in the pixel arranged area, based on whether a shift process for dithering is to be performed or not.

According to the present invention, pixel data process may be performed by a simple circuit configuration.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing a block configuration of one example of a display device according to a first exemplary embodiment of the present invention;

FIG. 2 is a flowchart showing a display control method according to the first exemplary embodiment;

FIG. 3 is a diagram schematically showing an LCD panel undergoing dithering;

FIG. 4 is a diagram schematically showing the LCD panel undergoing dithering;

FIG. 5A is a diagram showing the display control method according to the first exemplary embodiment;

FIG. 5B is a diagram showing the display control method according to the first exemplary embodiment;

FIG. 6 is a flowchart showing a display control method according to a second embodiment of the present invention;

FIG. 7 is a diagram schematically showing an LCD panel according to the second embodiment;

FIG. 8 is a diagram showing a block configuration of one example of a display device according to a third embodiment of the present invention;

FIG. 9A is a diagram schematically showing an LCD panel according to the third embodiment when the expansion factor is 3×3;

FIG. 9B is a diagram schematically showing the LCD panel according to the third embodiment when the expansion factor is 3×3;

FIG. 10A is a diagram schematically showing the LCD panel according to the third embodiment when the expansion factor is 1×2; and

FIG. 10B is a diagram schematically showing the LCD panel according to the third embodiment when the expansion factor is 1×2.

### DETAILED DESCRIPTION OF THE EXEMPLARY EMBODIMENTS

### First Exemplary Embodiment

Now, exemplary embodiments of the present invention will be described with reference to the accompanying drawings.

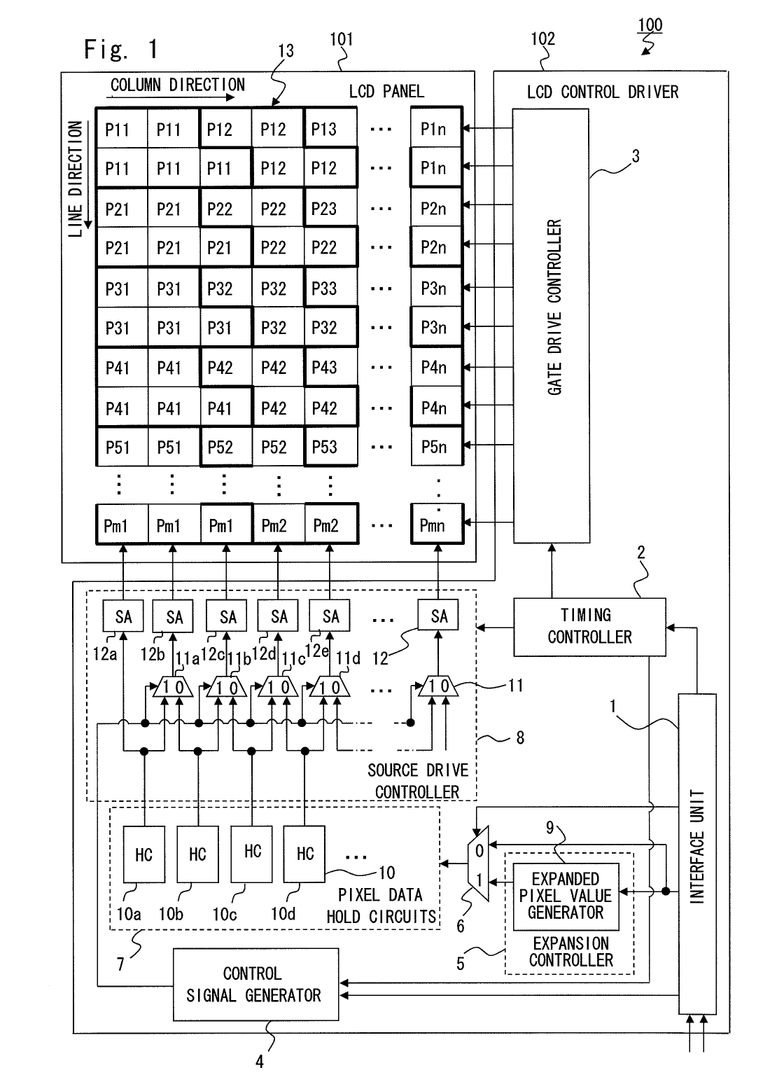

FIG. 1 is a diagram that shows a block configuration of a display device 100. As shown in FIG. 1, the display device 100 includes an LCD panel 101 (a display panel, an image display unit) and an LCD control driver (semiconductor integrated circuit) 102.

The LCD panel 101 includes a liquid crystal cell matrix (pixel arranged area, pixel arrangement area) 13. In the liquid crystal cell matrix 13, as shown in FIG. 1, multiple pixels P11, P12, P13, and the like are arranged in a 2m-line, 2n-column matrix (m and n represent positive integers). That is, 2m pixels are arranged in the line direction (vertical direction) and 2n pixels are arranged in the column direction (horizontal direction). In other words, 2n pixel columns are arranged and 2m pixel lines are arranged. Each pixel column is composed of multiple pixels arranged in the line direction. Each pixel line is composed of multiple pixels arranged in the column direction. A source (not shown) and a gate (not shown) are connected to each pixel. Note that the arrangement of pixels is arbitrary and should not be limited to FIG. 1.

FIG. 1 schematically shows a case where m-line n-column pixel data (display data) is displayed at an expansion factor of 2×2.

When displaying the expanded image, the area surrounded by the thick line shown in FIG. 1 forms a single pixel (pixel cell). When an image is displayed, a single pixel is composed of multiple pixels. For example, when displaying the expanded image, pixels P11 and P11 in the first line and pixels P11, P11, and P11 in the second line form a single pixel (see FIG. 1). Note that images are normally displayed on the smallest pixel unit basis.

As shown in FIG. 1, the LCD control driver 102 includes an interface unit 1, a timing controller 2, a gate drive controller 3, a control signal generator 4, a expansion controller 5 (expansion control means), a pixel data selector 6 (selection means), pixel data hold circuits 7, and a source drive controller 8. The expansion controller 5 includes an expanded pixel value generator 9. The pixel data hold circuits 7 include data hold circuits 10 (hold means), which are represented by “HC” in FIG. 1. The source drive controller 8 includes selectors 11 and source amplifiers 12.

The display device 100 also includes a controller (not shown) that includes a field programmable gate array (FPGA). The FPGA stores various programs for controlling the components of the display device 100. The controller executes those programs to control the components of the display device 100. The controller may include a large-scale integration (LSI) instead of the FPGA. The controller including the FPGA can rewrite the programs stored in the FPGA. Those programs can be stored in a storage medium.

The interface unit 1 receives pixel data (display data), various control signals, and the like from the outside of the LCD control driver 102, that is, from the controller of the display device 100.

The interface unit 1 inputs a timing control signal and an expansion determination signal into the timing controller 2. The interface unit 1 also inputs a determination signal DS_SEL (edge image processing determination signal) into the control signal generator 4. The interface unit 1 also inputs the original pixel data into the expansion controller 5 and pixel data selector 6. The interface unit 1 also inputs the expansion determination signal into the pixel data selector 6.

The timing controller 2 controls the operation timings of the gate drive controller 3, control signal generator 4, and source drive controller 8 in accordance with the timing control signal and the expansion determination signal inputted by the interface unit 1. Specifically, the timing controller 2 inputs a gate line control signal into the gate drive controller 3. The timing controller 2 also inputs a source line control signal into the source drive controller 8. The timing controller 2 also inputs a vertical synchronizing signal, a frame number signal, and a line number signal into the control signal generator 4.

The gate drive controller 3 controls the drive of gates (not shown) in accordance with the gate line control signal inputted by the timing controller 2. Specifically, the gate drive controller 3 inputs a gate voltage signal based on the gate line control signal into the corresponding gate of the LCD panel 101.

The control signal generator 4 generates a control signal (selector control signal) to control the switching states of the selectors 11 provided in the source drive controller 8 (this will be explained later). Specifically, the control signal generator 4 generates a control signal in accordance with the determination signal DS_SEL inputted by the interface unit 1 and the vertical synchronizing signal, frame number signal, and line number signal inputted by the timing controller 2.

The expansion controller 5 includes the expanded pixel value generator 9. The original pixel data (display data) inputted by the interface unit 1 is inputted into the expanded pixel value generator 9. The expanded pixel value generator 9 generates expanded pixel data (expanded-display data) having more pixel data than the original pixel data, and inputs the expanded pixel data into the pixel data selector 6.

The pixel data selector 6 selects one of the original pixel data inputted by the interface unit 1 and the expanded pixel data inputted by the expanded pixel value generator 9 in accordance with the expansion determination signal inputted by the interface unit 1, and inputs the selected data into the pixel data hold circuits 7.

The pixel data hold circuits 7 include the data hold circuits 10 (hold means). The data hold circuits 10 are provided corresponding to the pixel columns. In FIG. 1, the pixel data hold circuits 7 include the 2n data hold circuits 10 corresponding to the 2n pixel columns.

The data hold circuits 10 hold the original pixel data or expanded pixel data which are inputted by the pixel data selector 6. The data hold circuits 10 output the pixel data held by themselves to the selectors 11.

As shown in FIG. 1, the output terminal of a data hold circuit 10a is connected to a first input terminal of a selector 11a and to the input terminal of a source amplifier 12a. The output terminal of a data hold circuit 10b is connected to a second input terminal of the selector 11a and to a first input terminal of a selector lib. The output terminal of a data hold circuit 10c is connected to a second input terminal of the selector 11b and to a first input terminal of a selector 11c. The output terminal of a data hold circuit 10d is connected to a second input terminal of the selector 11c and to a first input terminal of a selector 11d.

The source drive controller 8 includes the selectors 11 and source amplifiers 12.

The selectors 11 are provided corresponding to 2n−1 pairs of pixel columns composed of two pixel columns that are positioned side by side in the 2n pixel columns. In other words, the selectors 11 are associated with the pairs of adjacent pixel columns. In FIG. 1, the 2n−1 selectors 11 are provided corresponding to the 2n−1 pairs of pixel columns included in the 2n pixel columns.

Each selector 11 receives pixel data from a pair of data hold circuits that is connected to said selector 11. Each selector 11 also receives a control signal from the control signal generator 4. Each selector 11 selects one of the pixel data inputted by both the data hold circuits 10 connected thereto in accordance with the control signal and inputs the selected pixel data into the corresponding source amplifier

The control signal generated by the control signal generator 4 is supplied to the select terminals of the selectors 11. Each selector 11 selectively outputs one of the data inputted into its first and second input terminals from the pair of data hold circuits in accordance with the control signal.

The source amplifiers 12 are provided corresponding to the pixel columns included in the LCD panel 101. In other words, the source amplifiers 12 are associated with the pixel columns included in the LCD panel 101. In FIG. 1, the source drive controller 8 includes the 2n source amplifiers 12 corresponding to the 2n pixel columns. Each source amplifier 12 inputs a source voltage signal based on the inputted pixel data into the corresponding source (not shown) of the LCD panel 101.

The source amplifiers 12 are provided corresponding to the pixel columns. In other words, the source amplifiers 12 are associated with the pixel columns. For example, the source amplifier 12a is provided corresponding to the pixel column (a pixel column composed of pixels P11, P11, P21, . . . , and Pm1 in FIG. 1) on the LCD panel 101, assuming that the diagram is viewed in front.

The source amplifiers 12 are also provided corresponding to the data hold circuits 10. For example, the source amplifier 12a is associated with the data hold circuit 10a, the source amplifier 12b is associated with the data hold circuit 10b, the source amplifier 12c is associated with the data hold circuit 10c, and the source amplifier 12d is associated with the data hold circuit 10d.

The source amplifier 12a receives pixel data from the data hold circuit 10a, the source amplifier 12b receives pixel data from the selector 11a, the source amplifier 12c receives pixel data from the selector 11b, the source amplifier 12d receives pixel data from the selector 11c, and the source amplifier 12e receives pixel data from the selector 11d.

Each selector 11 selects one of the pixel data separately inputted from the two data hold circuits 10 connected thereto, and supplies the selected pixel data to the source amplifier 12 to which said selector 11 is connected. In accordance with the selection states of the selectors 11, the selectors 11 turn ON/OFF of a shift process by which dithering processing (edge image processing) is to be performed.

In the example shown in FIG. 1, the source amplifiers 12 arranged in line from the left to the right in the diagram correspond to the data hold circuits 10 arranged in line from the left to the right in the diagram. The source amplifier 12a receives pixel data from the data hold circuit 10a. The source amplifier 12a always receives the pixel data supplied from the data hold circuit 10a, and this mechanism is irrelevant with whether the shift process is being performed or not.

In the explanation below, it may be assumed that number is counted from left side with viewing the diagram in front.

The Nth (N is an integer of 1 or more) selector 11 receives pixel data from the Nth data hold circuit 10 and from the (N+1)th data hold circuit 10. The Nth selector 11 then selects one of the pixel data received from the Nth data hold circuit 10 and the pixel data received from the (N+1)th data hold circuit 10, and inputs the selected pixel data into the (N+1)th source amplifier 12.

When performing the shift process, the Nth selector 11 inputs the pixel data received from the Nth data hold circuit 10 into the (N+1)th left source amplifier 12. In contrast, when the shift process is not being performed, the Nth selector 11 inputs the pixel data received from the (N+1)th data hold circuit 10 into the (N+1)th source amplifier 12. In this way, depending on whether a shift process is being performed or not, the Nth selector 11 outputs one of the pixel data received from the Nth and (N+1)th data hold circuits 10 to the (N+1)th source amplifier 12.

Note that the shift process is performed to achieve “Dithering”. “Dithering” refers to a process in which the display device 100 combines available colors in order to display a halftone color between the combined colors in order to display the half tone color that is not prepared as the available colors.

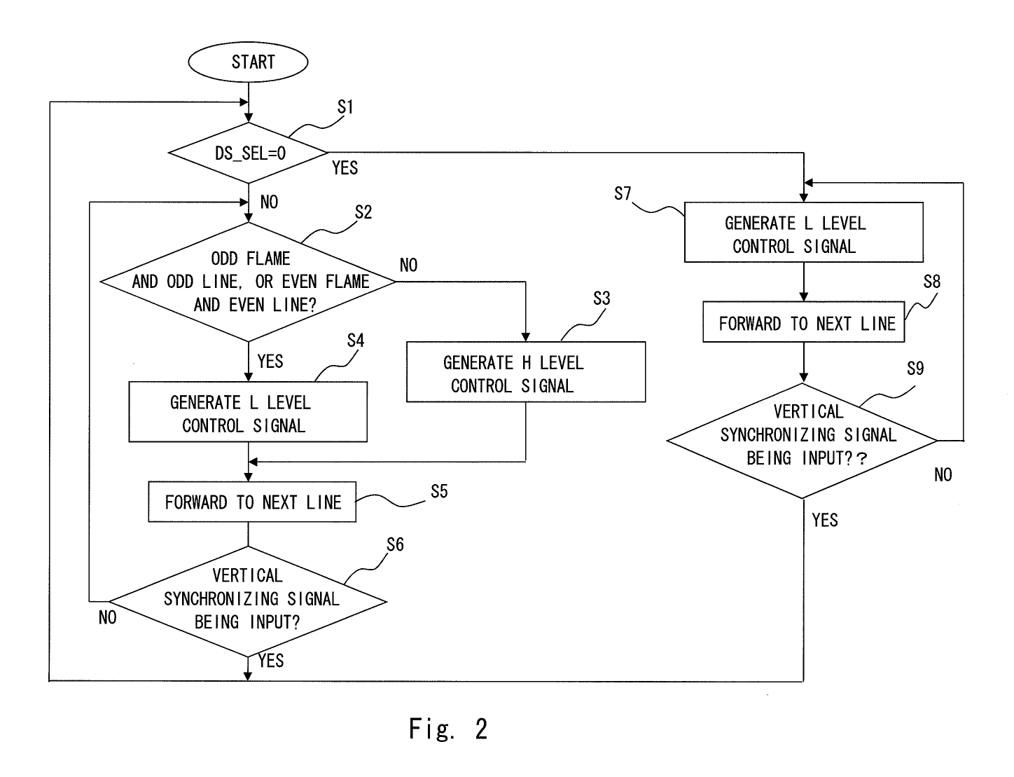

Hereinafter, a control signal generation process in a display control method according to the first exemplary embodiment will be described with reference to the flowchart shown in FIG. 2.

Firstly, the control signal generator 4 determines if dithering is OFF by determining whether the determination signal DS_SEL inputted by the interface unit 1 is 0 or not (step S1).

If the determination signal DS_SEL is not 0 in step S1 (step S1: No), the control signal generator 4 determines that dithering is ON.

The control signal generator 4 receives the frame number signal and the line number signal from the timing controller 2. In accordance with the received frame number and line number signals, the control signal generator 4 determines whether both the frame number and line number of expanded pixel data inputted into the pixel data hold circuits 7 are an odd number or even number (step S2).

The line number here refers to the number of pixel lines arranged in a matrix. The frame refers to the entire plane of the liquid crystal cell 13.

If both the frame number and line number of the expanded pixel data inputted into the pixel data hold circuits 7 are not an odd number or even number in step S2 (step S2: No), the control signal generator 4 inputs a high-level control signal into the selectors 11 (step S3).

If both the frame number and line number of the expanded pixel data inputted into the pixel data hold circuits 7 are an odd number or even number in step S2 (step S2: Yes), the control signal generator 4 inputs a low-level control signal into the selectors 11 (step S4).

The control signal generator 4 then proceeds to processing of the next line of the expanded pixel data inputted into the pixel data hold circuits 7 (step S5).

Subsequently, the control signal generator 4 determines whether the vertical synchronizing signal has been inputted by the timing controller 2 or not (step S6).

If no vertical synchronizing signal has been inputted by the timing controller 2 in step S6 (step S6: No), the process returns to step S2.

If a vertical synchronizing signal has been inputted by the timing controller 2 in step S6 (step S6: Yes), the process returns to step S1.

If the determination signal DS_SEL is 0 in step S1 (step S1: Yes), the control signal generator 4 determines that dithering is OFF. The control signal generator 4 then inputs a low-level control signal into the selectors 11 (step S7).

Next, the control signal generator 4 proceeds to processing of the next line of the expanded pixel data inputted into the pixel data hold circuits 7 (step S8).

Next, the control signal generator 4 determines whether a vertical synchronizing signal has been inputted by the timing controller 2 (step S9).

If no vertical synchronizing signal has been inputted by the timing controller 7 in step S9 (step S9: No), the process returns to step S7.

If a vertical synchronizing signal has been inputted by the timing controller 2 in step S9 (step S9: Yes), the process returns to step S1.

As apparent from the above description, in this exemplary embodiment, the selector selects one of pixel data supplied from the pair of data hold circuits connected thereto, and supplies the selected pixel data to a pixel column to which the selector is connected via the source amplifier. In other words, the selector selects one of pixel data supplied from the pair of data hold circuits connected thereto, and supplies the selected pixel data to one of the pair of pixel columns with which the pair of data hold circuits associated.

When supplying data to the pixel lines positioned at even lines from above, in the example shown in FIG. 1, each selector 11 selects an output of the data hold circuit which is not associated with the pixel column to which the output terminal of the selector 11 is connected via the source amplifier 12. On the other hand, when supplying data to the pixel lines positioned at odd lines from above, each selector 11 selects an output of the data hold circuit which is associated with the pixel column to which the output terminal of the selector 11 is connected via the source amplifier 12.

Thus, as shown in FIG. 1, a halftone between the color displayed in the second pixel column and the color displayed in the fourth pixel column can be displayed in the third pixel column, assuming that the pixel column number is counted from left viewing the diagram in front.

As apparent from FIG. 1, the pixel line at even line is shifted from adjacent upper pixel line at odd line rightward by one pixel. By controlling the selection state of the selectors 11 while supplying data to the pixel lines with sequentially shifting the target pixel line in the line direction, halftones between colors displayed on left and right pixel columns can be displayed on the middle pixel columns interposed between the left and right pixel columns. This makes it possible to perform dithering by a simple circuit configuration while suppressing an increase in current consumption.

The above-mentioned points will be further described. By controlling the selectors 11, pixel data to be inputted into pixels can be shifted in the column direction by one pixel. Thus, in displaying m-line, n-column pixel data on the LCD panel 101 where pixels are arranged in a 2m-line, 2n-column matrix shown in FIG. 1, pixel data from different data hold circuits 10 can be inputted into vertically adjacent two pixels in a pixel column. Also, data from different data hold circuits can be inputted into vertically adjacent two pixels positioned at the middle area interposed between areas for displaying one pixel data when displaying the expanded image.

Thus, in displaying the expanded image, the quality of the image can be corrected without using a complicated operation processing circuit for correcting image quality. This can reduce current consumption in the display magnification process.

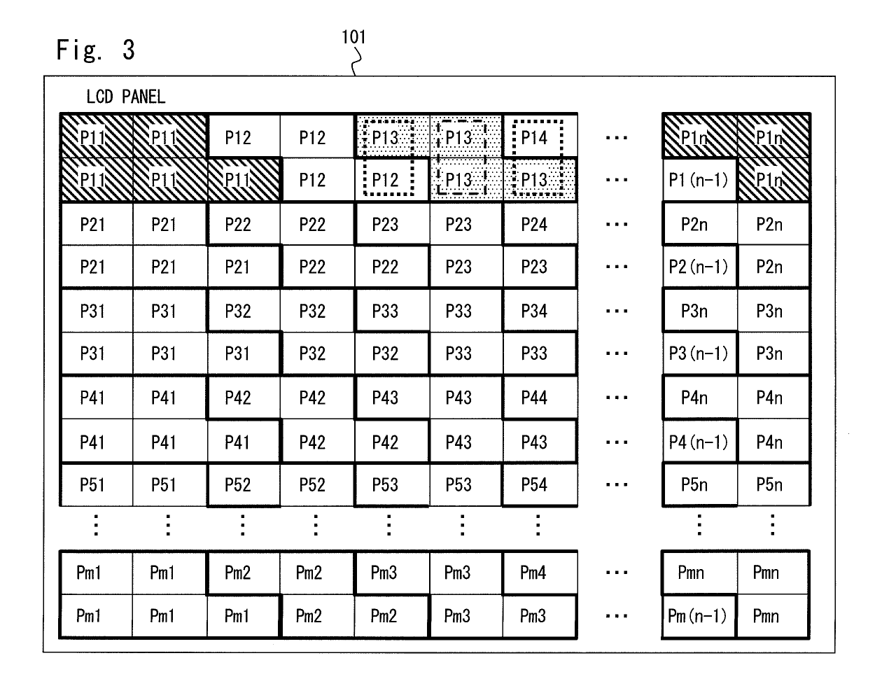

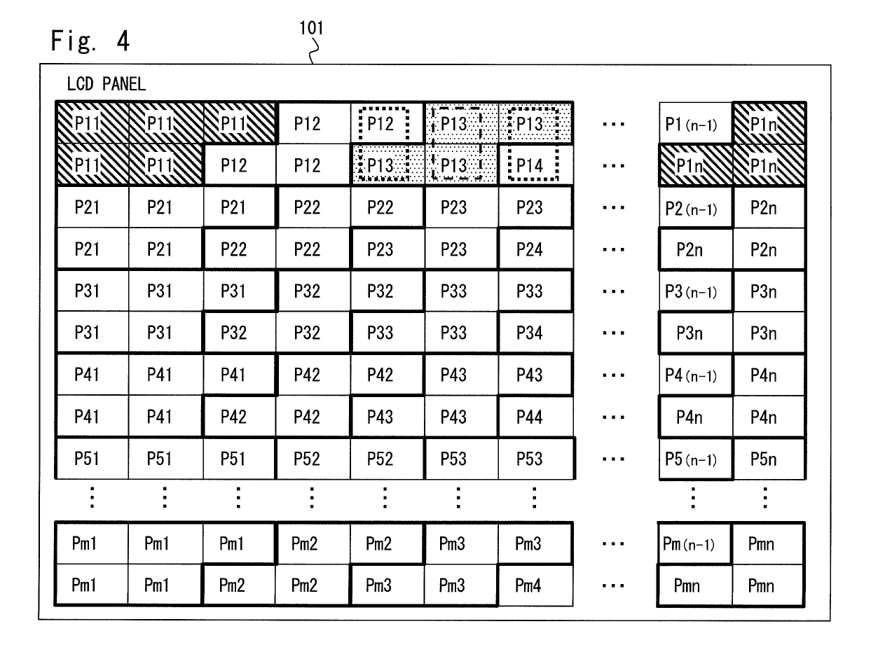

FIGS. 3 and 4 schematically show images displayed on the LCD panel 101 when the display device 100 is performing dithering using the display control method of the first exemplary embodiment.

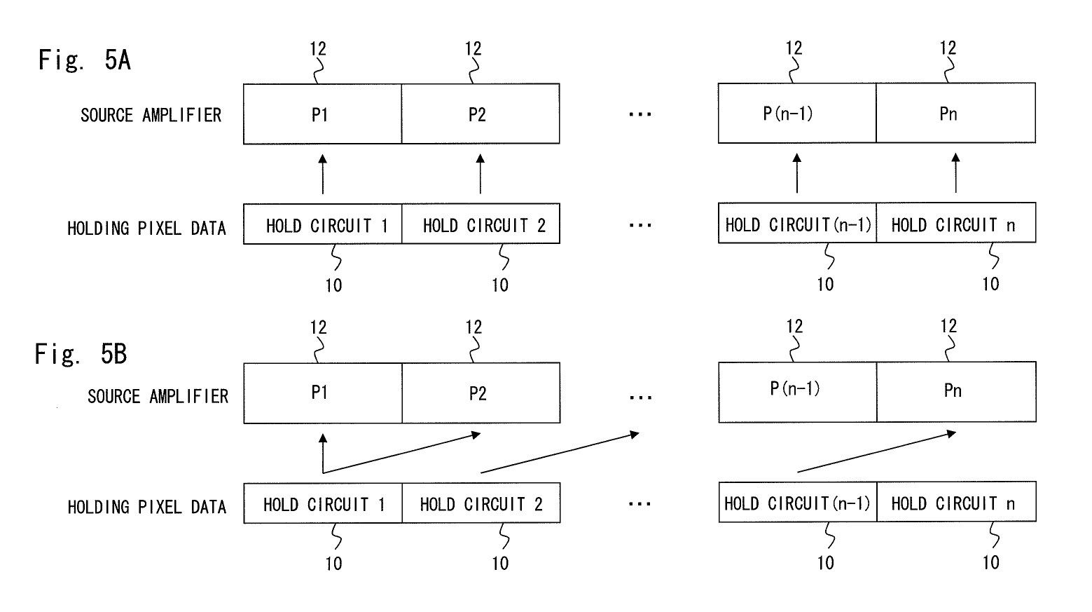

In FIG. 3, the LCD panel 101 displays the expanded image at an odd frame. In FIG. 4, the LCI panel 101 displays the expanded image at even frame. FIG. 5 is a diagram showing the operation of the source drive controller 8.

In FIG. 3, in the first line (first odd line), pixels P11, P11, P12, P12, P13, P13, P14, . . . , P1n, and P1n are arranged from the left in the order. In the second line (first even line), pixels P11, P11, P12, P12, P13, P13, . . . , P1(n−1), and P1n are arranged from the left in the order.

The pixels P11 and P11 in the first line and the pixels P11, P11, and P11 in the second line constitute the top pixel (pixel cell) in the odd frame. That is, when displaying the expanded image, the area surrounded by the thick line in FIG. 3 forms a single pixel.

The area composed of the fifth pixel P13 in the first line (first odd line) and the fifth pixel 12 in the second line (first even line) is subjected to dithering (see the area surrounded by the dotted line in FIG. 3).

Similarly, the area composed of the seventh pixel P14 in the first line and the seventh pixel 13 in the second line is subjected to dithering (see the area surrounded by the dotted line in FIG. 3).

The area composed of the sixth pixel P13 in the first line and the sixth pixel P13 in the second line is not subjected to dithering (see the area surrounded by the broken line in FIG. 3).

Similarly, dithering is performed between other odd pixel lines and even pixel lines. Specifically, pixels adjacent in the vertical direction (line direction) in each set of adjacent odd and even pixel lines are subjected to dithering.

In FIG. 4, in the first line (first odd line), pixels P11, P11, P11, P12, P12, P13, P13, . . . , P1(n−1), and P1n are arranged from the left in the order. In the second line (first even line), pixels P11, P11, P12, P12, P13, P13, P14, . . . , P1n, and P1n are arranged from the left in the order.

The pixels P11, P11, and P11 in the first line and the pixels P11 and P11 in the second line constitute the top pixel (pixel cell) on the even frame. That is, when displaying the expanded image, the area surrounded by the thick line shown in FIG. 4 forms a single pixel.

The area composed of the fifth pixel P12 in the first line (first odd line) and the fifth pixel 13 in the second line (first even line) is subjected to dithering (see the area surrounded by the dotted line in FIG. 4). Similarly, the area composed of the seventh pixel P13 in the first line and the seventh pixel 14 in the second line is subjected to dithering (see the area surrounded by the dotted line in FIG. 4).

The area composed of the sixth pixel P13 in the first line and the sixth pixel P13 in the second line is not subjected to dithering (see the area surrounded by the broken line in FIG. 4).

Similarly, pixels adjacent in the vertical direction (line direction) between other odd lines and even lines are subjected to dithering. Thus, halftones between colors displayed on left and right pixel columns can be displayed on the middle pixel columns interposed between the left and right pixel columns.

In the source drive controller 8 according to the first exemplary embodiment, each selector 11 selects pixel data inputted from two data hold circuits 10 connected thereto, as schematically shown in FIG. 5. The pixel data selected by each selector 11 is inputted into the corresponding source amplifier 12.

Each selector 11 turns ON/OFF of the shift process in order to perform dithering. In other words, dithering is turned ON or OFF depending on the operation of each selector 11.

FIG. 5A shows a case where the shift process is not being performed. As shown in FIG. 5A, when the shift process is not being performed, the selector 11 inputs pixel data inputted by the (N−1)th data hold circuit 10 (hold circuit (n−1)) into the (N−1)th source amplifier 12 (P(n−1)).

FIG. 5B shows a case where a shift process is being performed. As shown in FIG. 5B, when a shift process is being performed, the selector 11 inputs pixel data inputted by the (N−1)th data hold circuit 10 (hold circuit (n−1) in FIG. 5B) into the Nth source amplifier 12 (Pn in FIG. 5B).

In this way, the selectors 11 switch pixel data to be inputted into the source amplifiers 12. Thus, in the areas to be subjected to dithering shown in FIGS. 3 and 4, halftones between colors displayed on left and right pixels can be displayed on middle pixels interposed between the left and right pixels.

According to this exemplary embodiment, dithering can be performed with a simple circuit configuration without requiring a complicated operation processing circuit for correcting image quality when displaying the expanded image. Thus, current consumption in the display magnification process can be reduced as compared to previous current consumption.

### Second Exemplary Embodiment

A display device according to a second exemplary embodiment of the present invention has the same configuration as that of the display device 100 according to the first exemplary embodiment. Accordingly, the same elements are assigned the same reference numerals and will not be described. A display control method according to the second exemplary embodiment differs from that according to the first exemplary embodiment only with respect to the control signal generation process.

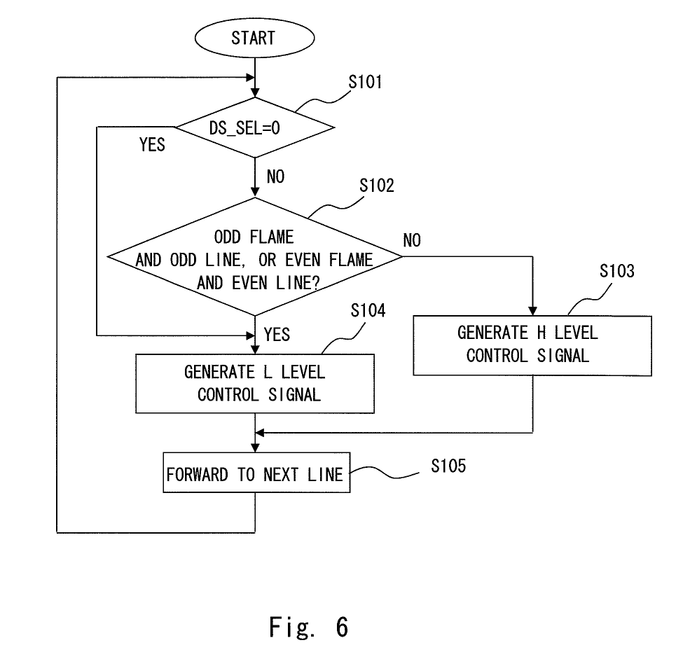

Hereafter, the control signal generation process in the display control method according to the second exemplary embodiment will be described with reference to the flowchart shown in FIG. 6. Firstly, the control signal generator 4 determines whether dithering is ON or OFF based on determining whether the determination signal DS_SEL inputted by the interface unit 1 is 0 or not (step S101).

If the determination signal DS_SEL is determined to be 0 in step S101 (step S101: Yes), the process proceeds to step S104.

If the determination signal DS_SEL is determined not to be 0 in step S101 (step S101: No), the control signal generator 4 determines that dithering is ON. The control signal generator 4 has already received a frame number signal and a line number signal from the timing controller 2. In accordance with the received frame number and line number signals, the control signal generator 4 determines whether both the frame number and line number of the expanded pixel data inputted into the pixel data hold circuits 7 are an odd number or even number (step S102).

If both the frame number and line number of the expanded pixel data inputted into the pixel data hold circuits 7 are not an odd number or even number in step S102 (step S102: No), the control signal generator 4 inputs a high-level control signal into the selectors 11 (step S103).

If both the frame number and line number of the expanded pixel data inputted into the pixel data hold circuits 7 are an odd number or even number in step S102 (step S102: Yes), the control signal generator 104 inputs a low-level control signal into the selectors 11 (step S104).

Next, the control signal generator 4 proceeds to processing of the next line of the expanded pixel data inputted into the pixel data hold circuits 7 (step S105) and returns to step S101.

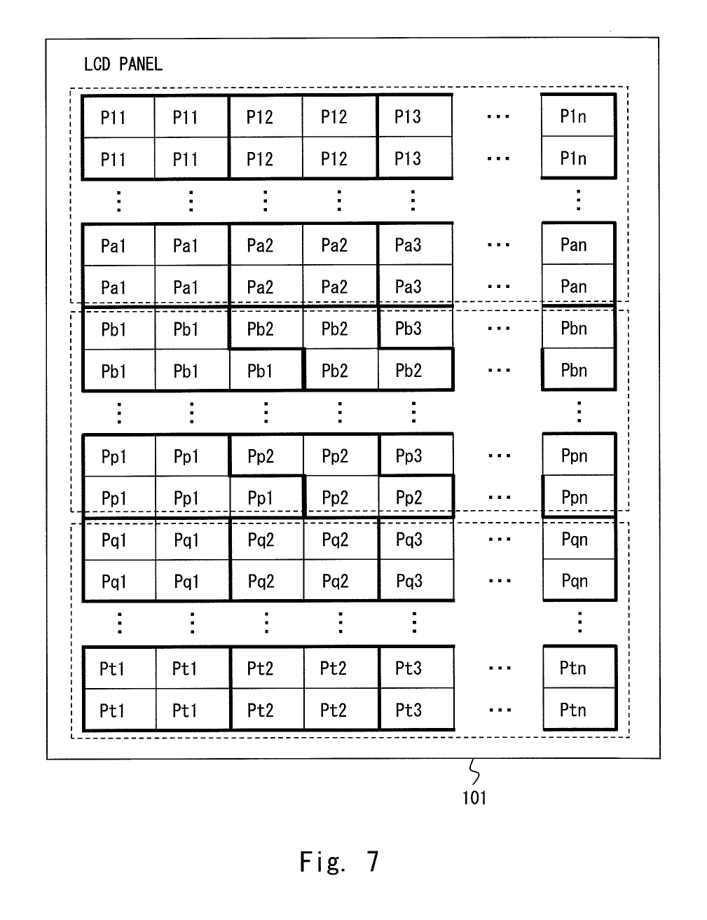

FIG. 7 schematically shows an exemplary image displayed by the LCD panel 101 when dithering is being performed as a result of the display control method according to this exemplary embodiment.

In FIG. 7, the area ranging from the upper-left pixel (first line, first column pixel) to the (2a)th line, (2n)th column pixel (a and n represent positive integers) is not subjected to dithering. Specifically, the area composed of P11, P11, P12, P12, P13, . . . , P1n, P11, . . . , P1n, . . . , Pa1, Pa1, Pa2, Pa2, Pa3, . . . , Pan, Pa1, . . . , Pan is not subjected to dithering.

On the other hand, the area ranging from the bth line, first column pixel (b represents a positive integer meeting b>a) to the (2p)th line, (2n)th column pixel (p represents a positive integer meeting p>b) is subjected to dithering.

Further, the area ranging from the qth line, first column pixel (q represents a positive integer meeting q>p) to the (2t)th line, (2n)th column pixel (t represents a positive integer meeting t>q) is not subjected to dithering.

As explained above, in the display control method according to this exemplary embodiment, a single frame is divided into the area to be subjected to dithering and the areas not to be subjected to dithering.

In the display control process of pixel data to be inputted into the area ranging from the first line, first column pixel to the (2a)th line, (2n)th column pixel, the controller (not shown) of the display device 100 generates a control signal for turning off dithering. Similarly, in the display control process of pixel data to be inputted into the area ranging from the q-th line, first-column pixel to the (2t)th line, (2n)th column pixel, the controller of the display device 100 generates a control signal for turning off dithering. The controller of the display device 100 is disposed outside the LCD control driver 102.

The control signals generated by the controller of the display device 100 are inputted into the interface unit 1. The interface unit 1 inputs a determination signal DS_SEL of “0” into the control signal generator 4. Thus, the area ranging from the first line, first column pixel to the (2a)th line, (2n)th column pixel and the area ranging from the qth line, first column pixel to the (2t)th line, (2n)th column pixel are set as areas not to be subjected to dithering.

On the other hand, in the display control process of pixel data to be inputted into the area ranging from the bth line, first column pixel to the (2p)th line, (2n)th column pixel, the controller of the display device 100 generates a control signal for turning on dithering. The control signal generated by the controller of the display device 100 is inputted into the interface unit 1. The interface unit 1 inputs a determination signal DS_SEL of “1” into the control signal generator 4. Thus, the area ranging from the bth line, first column pixel to the pth line, nth column pixel can be set as an area to be subjected to dithering.

In contrast with the first exemplary embodiment, the display control method according to this exemplary embodiment additionally provides a manner in which dithering can be performed on a unit line basis. In this exemplary embodiment, the LCD panel 101 is divided into plural line units and dithering can be performed on the line unit basis. Thus, the line unit to be subjected to dithering and the line unit not to be subjected to dithering can be determined in a single frame preferably. That is, according to this exemplary embodiment, in displaying the expanded image, the area to be subjected to dithering and the area not to be subjected to dithering can be set on a single frame preferably.

### Third Exemplary Embodiment

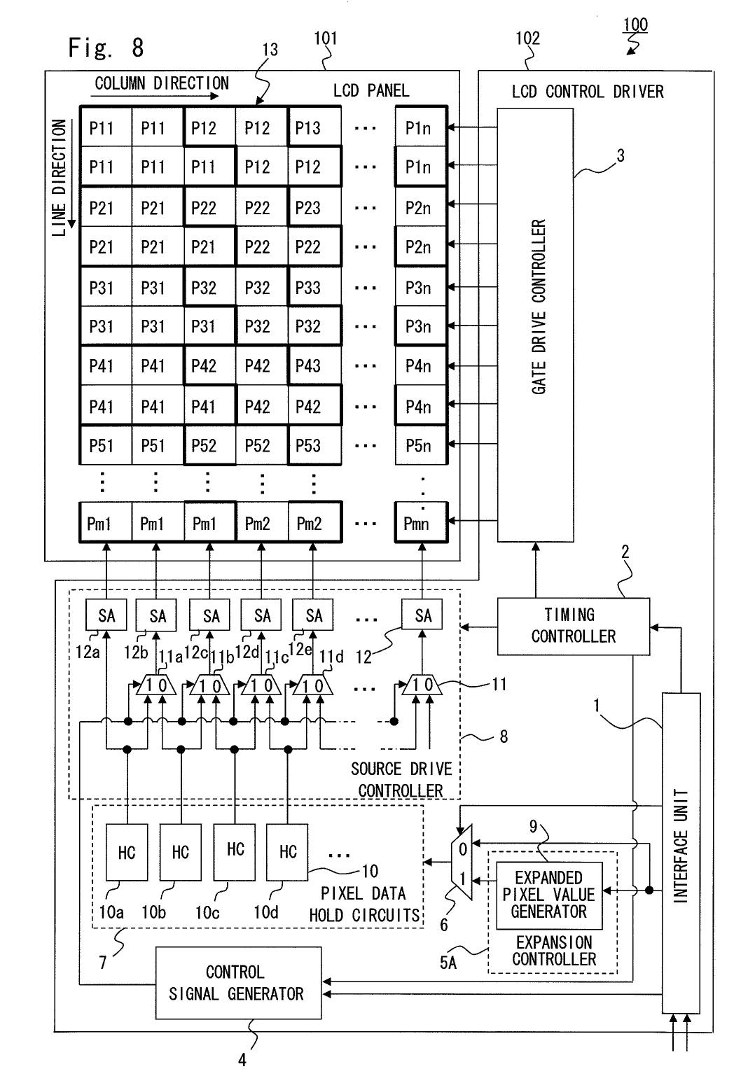

FIG. 8 is a diagram showing a block configuration of one example of a display device 200 according to a third exemplary embodiment of the present invention. An interface unit 1A, a expansion controller 5A, and an expanded pixel value generator 9A of the display device 200 according to the third exemplary embodiment have different configurations from those of the corresponding components of the display device 100 according to the first exemplary embodiment. The same components are assigned the same reference numerals and will not be described.

The interface unit 1A receives pixel data, various control signals, and the like from the outside of the LCD control driver 102, that is, from the controller of the display device 100.

The interface unit 1A inputs a timing control signal and an expansion determination signal into the timing controller 2. The interface unit 1A inputs a determination signal DS_SEL into the control signal generator 4. The interface unit 1A also inputs the original pixel data into the expansion controller 5A and pixel data selector 6. The interface unit 1A also inputs an expansion factor signal into the pixel data selector 5A. The interface unit 1A also inputs a expansion determination signal into the pixel data selector 6. An expansion factor signal is a signal for setting an expansion factor such as 2×2 or 3×3.

The expansion controller 5A includes the expanded pixel value generator 9A. The original pixel data inputted by the interface unit 1A is inputted into the expanded pixel value generator 9A. The expansion factor signal inputted by the interface unit 1A is inputted into the expanded pixel value generator 9A. The expanded pixel value generator 9A generates expanded pixel data at an expansion factor that is based on the expansion factor signal, and inputs the expanded pixel data into the pixel data selector 6.

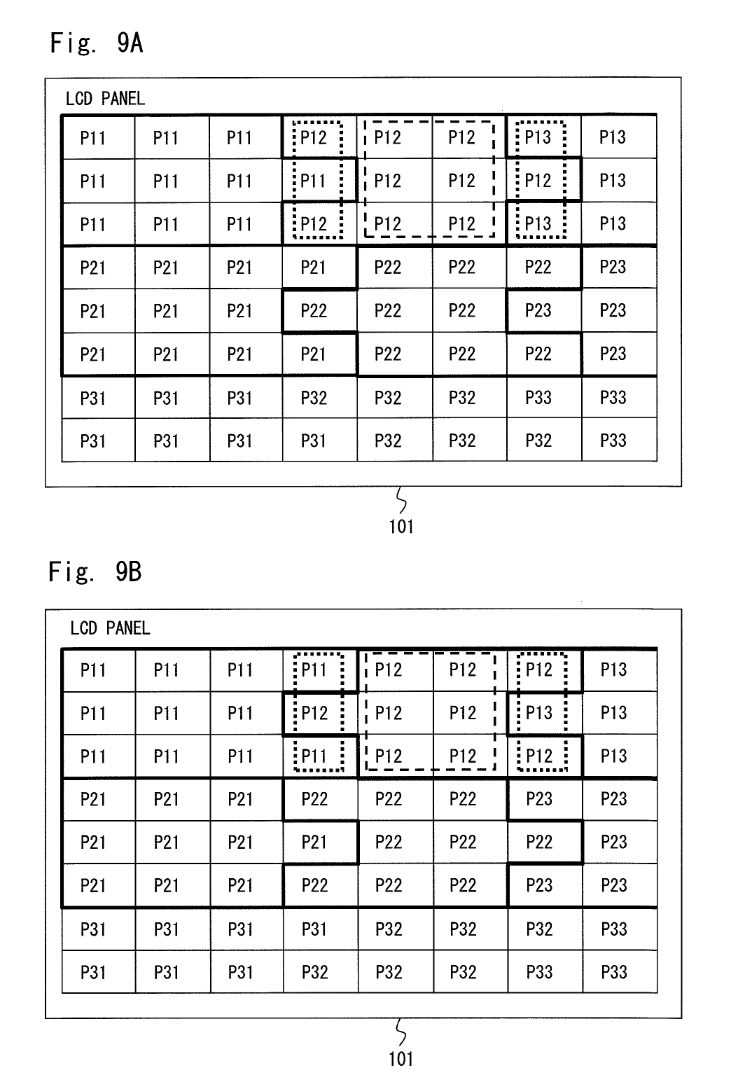

FIGS. 9A and 9B schematically show images displayed by the LCD panel 101 when the expansion factor set based on the expansion factor signal is 3×3. In FIGS. 9A and 9B, the area surrounded by the thick line on the LCD panel 101 forms a single pixel. In the area ranging from the first line, fourth column pixel to the third line, seventh column pixel on the LCD panel 101, the areas surrounded by the dotted lines are subjected to dithering. The area surrounded by the broken line is not subjected to dithering.

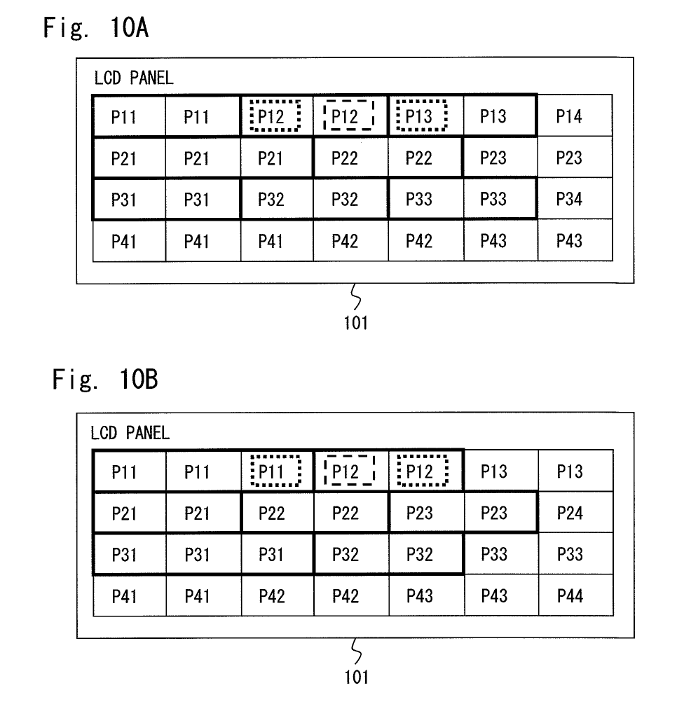

FIGS. 10A and 10B schematically show images displayed by the LCD panel 101 when the expansion factor set based on the expansion factor signal is 1×2. In FIGS. 10A and 10B, the area surrounded by the thick line on the LCD panel 101 forms a single pixel.

In the area ranging from the first line, third column pixel to the first line, fifth column pixel, the areas surrounded by the dotted lines are subjected to dithering. The area surrounded by the broken line is not subjected to dithering.

As in the first exemplary embodiment, the selectors 11 switch between pixel data to be inputted into the source amplifiers 12. This allows displaying halftones between colors displayed on left and right pixels in the middle areas to be subjected to dithering shown in FIGS. 9A and 9B and FIGS. 10A and 10B.

According to this exemplary embodiment, dithering can be performed with a simple circuit configuration. Further, this exemplary embodiment does not require a complicated operation processing circuit for correcting image quality when displaying the expanded image. These can reduce current consumption in the display magnification process.

The present invention is not limited to the above-mentioned exemplary embodiments and changes can be made thereto as appropriate without departing from the spirit and scope of the invention. For example, a certain selector 11 may receive outputs of three or more data hold circuits 10 corresponding to three or more pixel columns disposed continuously in the column direction and then selectively output one of the received outputs.

What is claimed is:

1. A semiconductor integrated circuit comprising:
a plurality of data hold circuits that are associated with a plurality of pixel columns arranged in a pixel arranged area where a plurality of pixels are arranged in matrix, each of the plurality of data hold circuits being configured to hold data which is to be supplied to the pixel column; and
a plurality of selectors, each selector being configured to selectively supply, based on whether a shift process for dithering is to be performed or not, one of outputs of a pair of data hold circuits coupled to said selector to the pixel column included in a pair of pixel columns that is associated with said pair of data hold circuits, said pair of pixel columns comprising pixel columns positioned side by side in the pixel arranged area.

2. The semiconductor integrated circuit according to claim 1, wherein when performing the shift process, each selector supplies the output of the data hold circuit that is not associated with said pixel column included in the pair of pixel columns to which the data is supplied from the selector.

3. The semiconductor integrated circuit according to claim 1, wherein
the pixel arranged area includes N pixel columns, N indicating a natural number of 2 or more, and
N−1 selectors are associated with N−1 pairs of pixel columns included in the N pixel columns.

4. The semiconductor integrated circuit according to claim 1, further comprising:
a control signal generator that generates a control signal for setting selection states of the selectors, wherein
the control signal generator generates the control signal based on information indicating which pixel line the data held by the plurality of data hold circuits are supplied to.

5. The semiconductor integrated circuit according to claim 4, wherein the control signal generator generates the control signal based on number of frame of an image to be displayed in addition to said information.

6. The semiconductor integrated circuit according to claim 4, wherein
the control signal generator operates based on a determination signal for determining whether to generate the control signal or not, and
a signal value of the determination signal is determined by whether to perform dithering or not against a sub-area that is formed by dividing the pixel arranged area.

7. The semiconductor integrated circuit according to claim 1, wherein, when dithering is being performed, the same data are held in the same group of data hold circuits which are defined by grouping the plurality of data hold circuits.

8. The semiconductor integrated circuit according to claim 3, further comprising N source amplifiers that are associated with the N pixel columns.

9. The semiconductor integrated circuit according to claim 8, wherein the N source amplifiers include:
a first source amplifier coupled between the data hold circuit and the pixel column; and
a plurality of second source amplifiers, each second source amplifier being coupled between the selector and the pixel column.

10. The semiconductor integrated circuit according to claim 1, wherein the plurality of data hold circuits include first to third data hold circuits and the plurality of selectors include first and second selectors, and wherein
outputs of the first and second data hold circuits are respectively supplied to first and second input terminals of the first selector, and outputs of the second and third data hold circuits are respectively supplied to first and second input terminals of the second selector.

11. The semiconductor integrated circuit according to claim 10, wherein selection states of the first and second selectors are determined by a common control signal supplied from a control signal generator.

12. The semiconductor integrated circuit according to claim 11, further comprising first to third source amplifiers,
wherein the first source amplifier receives data output from the first data hold circuit, the second source amplifier receives data output from the first selector, and the third source amplifier receives data output from the second selector.

13. A display device comprising:
the semiconductor integrated circuit of claim 1; and
an image display unit that displays an image on the pixel arranged area.

14. A display control method comprising:
holding data by a plurality of data hold circuits that are associated with a plurality of pixel columns included in a pixel arranged area where a plurality of pixels are arranged in matrix; and
selectively supplying one of outputs of a pair of data hold circuits to the pixel column included in a pair of pixel columns, which is associated with said pair of data hold circuits and comprises pixel columns positioned side by side in the pixel arranged area, based on whether a shift process for dithering is to be performed or not.

15. The display control method according to claim 14, wherein when performing the shift process, the output of the data hold circuit, which is not associated with said pixel column of the pair of pixel columns to which the data is supplied from the selector, is supplied to said pixel column of the pair of pixel columns.

16. The display control method according to claim 15, wherein a period of performing the shift process is determined based on information indicating which pixel line the data held in the plurality of data hold circuits are supplied to.
